(19) United States
(12) Patent Application Publication
(10) Pub. No.: US 2022/0241649 A1
(43) Pub. Date: Aug. 4, 2022

(54) DEVICES, SYSTEMS, AND METHODS FOR AN EXERCISE DEVICE AUTOMATIC SHUT-OFF

(71) Applicant: iFIT Inc., Logan, UT (US)

(72) Inventor: Darren C. Ashby, Richmond, UT (US)

(21) Appl. No.: 17/589,075

(22) Filed: Jan. 31, 2022

Related U.S. Application Data
(60) Provisional application No. 63/144,246, filed on Feb. 1, 2021.

(51) Int. Cl. A63B 24/00; A63B 21/22; A63B 22/06

(52) U.S. Cl. CPC A63B 24/0087; A63B 21/225; A63B 22/06; A63B 2220/40; A63B 2225/50; A63B 2220/62; A63B 2220/803

(57) ABSTRACT

An exercise device includes a use-sensor connected to a flywheel. The use-sensor detects motion of the flywheel. If the flywheel is moving, a power interrupt on a power supply connects power to the exercise device. If the flywheel is not moving, the power interrupt disconnects power from the exercise device, thereby improving device safety.

### CROSS-REFERENCE TO RELATED APPLICATIONS

This application claims priority to and the benefit of U.S. Provisional Patent Application No. 63/144,246, filed on Feb. 1, 2021, which is hereby incorporated by reference in its entirety.

### BACKGROUND

### Background and Relevant Art

Physical exercise is beneficial to physical and mental health. Some people choose to exercise indoors on an exercise device, such as a treadmill, a stationary bicycle, an elliptical machine, a rower, and combinations thereof. Many commercial gyms operate multiple exercise devices, and a user may travel to a commercial gym to use an exercise device. Some users may use an exercise device at home, work, a community center, or other location.

Exercise devices often include electrically powered systems. Such systems may change exercise device settings, such as incline, resistance level, and so forth. Electrically powered systems may further include sensors to gather exercise information and processors configured to process the exercise information. Some exercise devices generate their own power, such as through a motor driven by the user's motion. Some exercise devices receive power from a power source, such as an external battery and/or a power outlet connected to a power grid.

### BRIEF SUMMARY

In some embodiments, an automatic shut-off system includes a power connector and a flywheel. A use sensor is configured to detect a motion of the flywheel. A power interrupt located on the power connector between the power source and the exercise device is configured to disconnect the exercise device from the power source with the motion sensor detects that the flywheel is not moving. In some embodiments, an exercise controller may be connected to the power supply and configured to change one or more device configurations.

In some embodiments, a method for powering an exercise device includes detecting a motion of a flywheel with a use-sensor and determining whether the flywheel is moving. After determining whether the flywheel is moving, and if the flywheel is not moving, a power interrupt disconnects the exercise device from a power source.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a schematic representation of an automatic-shut-off system for an exercise device, according to at least one embodiment of the present disclosure;

FIG. 2 is schematic representation of another exercise device, according to at least one embodiment of the present disclosure;

FIG. 3 is a representation of a flow chart of a method for controlling power for an exercise device, according to at least one embodiment of the present disclosure;

FIG. 4 is a representation of a flow chart of another method for controlling power for an exercise device, according to at least one embodiment of the present disclosure;

FIG. 5 is a representation of a stationary bicycle, according to at least one embodiment of the present disclosure;

FIG. 6 is a representation of an elliptical machine, according to at least one embodiment of the present disclosure; and

FIG. 7 is a representation of a rower, according to at least one embodiment of the present disclosure.

### DETAILED DESCRIPTION

This disclosure generally relates to devices, systems, and methods for providing an automatic shut-off system for an exercise device based on whether a flywheel is in motion. The flywheel may include a motion sensor, such as an accelerometer, that senses the motion of the flywheel. The motion sensor may be in communication with a power interrupt on a power connector. When the flywheel is in motion, then the sensor may communicate the motion to the power interrupt, and the power interrupt may connect power to the exercise device. When the flywheel is stopped, then the sensor may communicate the lack of motion to the power interrupt, and the power interrupt may disconnect power to the exercise device. This may help to prevent unwanted activation and operation of the exercise device, thereby improving the safety of the device.

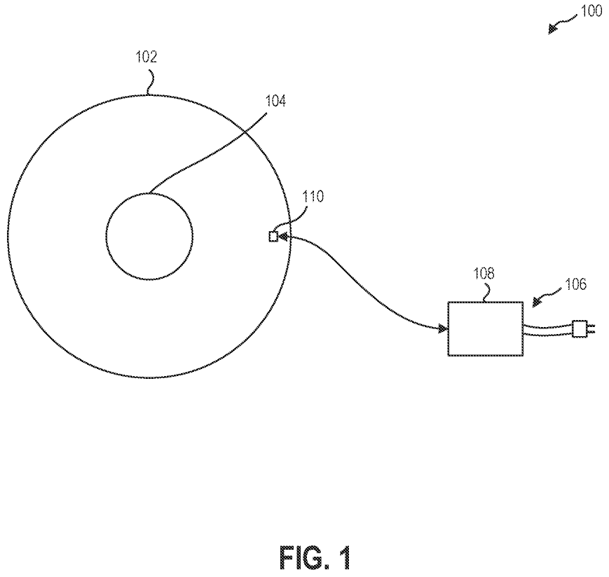

FIG. 1 is a schematic representation of an exercise system 100, according to at least one embodiment of the present disclosure. The exercise system 100 includes a resistance element, such as a flywheel 102. In accordance with embodiments of the present disclosure, the flywheel 102 may be any type of resistance element, such as a flywheel. In some embodiments, the flywheel 102 may be moved by a movable element which may cause the flywheel to rotate about an axle 104. For example, the flywheel 102 may be connected to a drive chain of a stationary bicycle. A user may rotate one or more pedals with his or her feet. The pedals may be attached to a crank, which may cause a drive wheel to rotate. The drive wheel may be connected to the flywheel 102 with a chain or belt such that as the drive wheel is rotated, the resistance element 102 is likewise rotated. In some embodiments, the movable element may include pedals of an elliptical machine, a pull and cable for a rower, a pull and cable for strength exercises, any other movable element, and combinations thereof. In some embodiments, the flywheel 102 may be a flywheel on a treadmill.

Rotating the flywheel 102 may cause resistance for the user during an exercise. For example, the flywheel 102 may have a mass and the resistance may include rotating the mass of the flywheel 102. In some embodiments, the resistance may include starting the flywheel 102 rotating from a stationary position. In some embodiments, the resistance may include keeping the flywheel 102. The flywheel 102 may experience resistance to rotation, such as through friction from the air or from a brake. In some embodiments, the brake may be a mechanical brake. In some embodiments, the brake may be a magnetic brake.

In some embodiments, an exercise device may include one or more powered systems. A power connector 106 may supply power or be configured to supply power to the powered systems of the exercise device. For example, the power connector 106 may connect an exercise controller to a power supply so that the exercise controller may change exercise elements of the exercise device (e.g., incline, resistance, speed). The power connector 106 may include an automatic shut-off system, such as a power interrupt 108. The power interrupt 108 may be located between the exercise device and the power supply. In other words, the power interrupt 108 may be located on the power connector between the exercise device and the power supply such that the power interrupt 108 is capable of interrupting the power connection between the power supply and the exercise device. For example, the power interrupt 108 may be able to connect and disconnect power to the exercise device by operating a switch to open and close a connection in the power connector 106.

In some embodiments, the power interrupt 108 may be an automatic shut-off. In other words, the power interrupt 108 may be configured to automatically disconnect power to the exercise device. The power interrupt 108 may automatically disconnect power to the exercise device based on one or more conditions. For example, the power interrupt 108 may connect and/or disconnect power to the exercise device based on whether the exercise device is being used. In this manner, the exercise device may only receive power when in use. This may help to reduce the risk of an electrical short, an electrical overload, or other electrical problems. This may help to reduce the risk of fire or other damage to the exercise device and/or the users and home of the users caused by electrical problems.

In some embodiments, the exercise device may include a use-sensor 110. The use-sensor 110 may detect use of the exercise device. The use-sensor 110 may detect use of the exercise device in any manner. For example, the use-sensor may be connected to the flywheel 102. The use-sensor may detect a motion of the flywheel 102. As discussed above, the flywheel 102 will rotate when the exercise device is in use, either through the user applying a force on the flywheel 102 through the movable element or by being driven by a motor. Thus, by placing the use-sensor 110 on the flywheel 102, the use-sensor 110 may help to determine whether the exercise device is in use.

The use-sensor 110 may be in communication with the power interrupt 108. The use-sensor 110 may send a signal to the power interrupt 108 indicating whether the exercise device is being used. If the signal indicates that the exercise device is in use, then the power interrupt 108 may connect power to the exercise device through the power connector 106. If the signal (or lack thereof) indicates that the exercise device is not in use, then the power interrupt 108 may disconnect power from the exercise device.

The use-sensor 110 may detect use of the exercise device through the flywheel 102 in any manner. For example, the use-sensor 110 may be a motion sensor configured to detect rotation of the flywheel 102. If the motion sensor detects that the flywheel 102 is rotating, then the motion sensor may transmit the motion to the power interrupt 108. In some examples, the use-sensor 110 may be an accelerometer such that the accelerometer detects the motion of the flywheel 102. In some embodiments, the accelerometer may be configured to measure multiple axes. The accelerometer may be oriented to measure a rotational acceleration. If the accelerometer measures a rotational acceleration, then the accelerometer may send a signal to the power interrupt indicating that the exercise device is in use. If the accelerometer measures an acceleration other than a rotational acceleration, then the accelerometer may determine that the flywheel is not in use (e.g., the exercise device could be in transport, moved around a user's apartment, and so forth). In some embodiments, the use-sensor 110 may be any other type of sensor. For example, the use-sensor may be a force-sensor configured to determine the presence of a radially outward force.

In accordance with embodiments of the present disclosure, the power interrupt 108 may have a threshold signal limit. For example, the use-sensor 110 may send a signal that is representative of a rotation of the flywheel 102. The power interrupt 108 may have a minimum flywheel rotation to provide power to the exercise device. The power interrupt 110 may determine the flywheel rotation using information received from the use-sensor 110. If the signal received from the use-sensor 110 is above the threshold signal limit, then the power interrupt 108 may determine that the exercise device is being used and may connect power to the exercise device. Put another way, the power interrupt 108 may determine that the flywheel is being intentionally rotated by the user. If the signal received from the use-sensor 110 is below the threshold signal limit, then the power interrupt 108 may determine that the exercise device is not being used. Put another way, the power interrupt 108 may determine that the flywheel 102 is not being rotated or that the flywheel 102 is being moved accidently (such as by bumping, jostling, moving of the exercise device, and so forth).

In some embodiments, the flywheel 102 has a threshold motion to determine whether the exercise device is in use. The threshold motion may be any type of motion, for example, the threshold motion may be a threshold rotational acceleration. In some examples, the threshold motion may be a threshold number of rotations. In some embodiments, if the detected rotation of the flywheel 102 is greater than the threshold, then the power interrupt 108 may connect power to the exercise device. If the detected rotation of the flywheel 102 is less than the threshold, then the power interrupt 108 may disconnect power to the exercise device. For example, the threshold may be a threshold rotational acceleration. The power interrupt 108 may determine that the detected rotational acceleration is less than the threshold rotational acceleration before disconnecting the power from the exercise device.

In some embodiments, the power interrupt 108 may determine that the exercise device is being used if the signal received from the use-sensor 110 indicates that the flywheel 102 has undergone a revolution percentage (e.g., the angle of the flywheel rotated divided by 360). For example, the power interrupt 108 may determine that the exercise device is being used if the flywheel 102 undergoes a revolution percentage of 10%, 25%, 50%, 75%, 100%, 150%, 200%, or any value therebetween. Determining that the flywheel 102 has undergone the revolution percentage may provide an indication that the flywheel 102 is being rotated intentionally, and therefore that the exercise device is being used.

In some embodiments, the use-sensor 110 may only be powered when the exercise device is in use. For example, the flywheel 102 may include one or more power generators that generate power when the flywheel 102 is rotating. The use-sensor 110 may be configured to automatically send a signal to the power interrupt 108 when it receives power from the one or more power generators.

In some embodiments, the use-sensor 110 and the power interrupt 108 may have separate power sources (e.g., the use-sensor 110 and the power interrupt 108 may be separately powered). For example, the use-sensor 110 may be powered by power generated by rotation of the flywheel 102, and the power interrupt 108 may be powered by power received from the outlet. In some embodiments, the use-sensor 110 and the exercise device may have separate power sources. For example, the power interrupt 108 may include a controller switch that connects and disconnects power to the controller of the exercise device. A sensor power connection, separate from the controller switch, may extend from the use-sensor 110 to the power interrupt 108. In this manner, the use-sensor 110 may receive power even when power interrupt 108 has disconnected power to the main exercise device.

In some embodiments, the use-sensor 110 may continuously provide a signal to the power interrupt 108. The power interrupt 108 may receive and interpret the signal received from the use-sensor 110. In some embodiments, the power interrupt 108 may determine that the exercise device is in use if, based on the signal received from the use-sensor 110, it determines that the flywheel 102 has been moving for a threshold duration. In some embodiments, the threshold duration may be 0.1 s, 0.25 s, 0.5 s, 0.75 s, 1.0 s, 2.0 s, or any value therebetween. This may help prevent the power interrupt 108 from providing power to the exercise device when the exercise device is not in use.

In some embodiments, the power interrupt 108 may determine whether the exercise device is in use. For example, the use-sensor 110 may provide sensor data to the power interrupt 108, and the power interrupt 108 may interpret the sensor data to determine whether the exercise device is in use, as discussed herein. In some embodiments, the use-sensor 110 may determine whether exercise device is in use. For example, the use-sensor 110 may interpret the sensor data it collects and determine whether the exercise device is in use, as discussed herein. The use-sensor 110 may then communicate the status of the exercise device (e.g., in-use or not in-use) to the power interrupt 108.

In some embodiments, the use-sensor 110 may only send a signal to power interrupt 108 to send sensor data and/or indicate the status of the exercise device. In some embodiments, the use-sensor 110 may be in continuous communication with the power interrupt 108 when the exercise device is in use. If the use-sensor 110 stops communicating with the power interrupt 108, then the power interrupt 108 may infer that the exercise device is no longer in use, and the power interrupt 108 may disconnect power to the exercise device.

In some embodiments, the use-sensor 110 may be in wireless communication with the power interrupt 108 using a wireless connection, including wireless communication protocols as Wi-Fi, Bluetooth, Zigbee, NFC, infrared signals, any other wireless communication protocol, and combinations thereof. In some embodiments, the use-sensor 110 may be in wired communication with the power interrupt 108 using a wired connection.

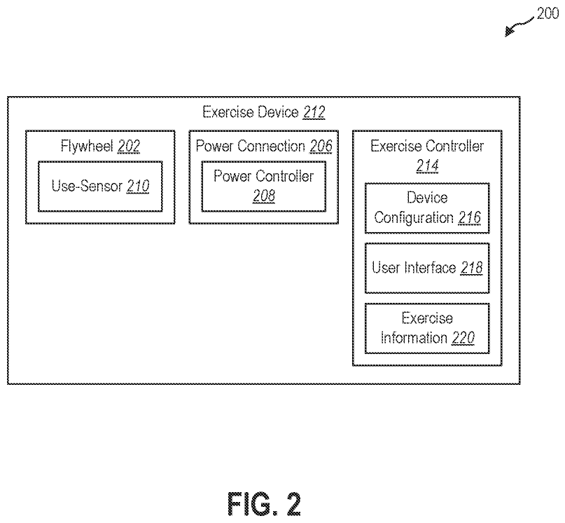

FIG. 2 is a representation of an exercise system 200, according to at least one embodiment of the present disclosure. The exercise system 200 includes an exercise device 212 having a resistance element, such as the flywheel 202. The exercise controller 214 of exercise device 212 may receive power from a power connection 206. In some embodiments, the exercise controller 214 may control any element of the exercise device 212, collect exercise information to the user, display exercise information to the user, communicate with a remote computing device, perform any other function related to the exercise device, and combinations thereof.

In some embodiments, the exercise controller 214 may be configured to change one or more elements of the device configuration 216, such as resistance level, incline level, belt speed, seat position, handle position, footrest position, any other device configuration 216 element, and combinations thereof. In some embodiments, the exercise controller 214 may include one or more exercise programs that involve periodic changes in the device configuration 216, such as changes in the incline and/or resistance. The device controller 214 may execute an exercise program by making the changes to the device configuration automatically, without user input.

In some embodiments, the device controller 214 may include a user interface 218. Through the user interface 218, a user may input commands and/or information into the exercise device. For example, the user may select an exercise program, change one or more elements of the device configuration 216, input user information such as weight, height, exercise goals, select media content to consume while exercising (or otherwise), provide any other input, and combinations thereof. In some embodiments, the user interface 218 may be any type of interface, including one or more physical buttons located somewhere on the exercise device, a touch-screen display, a microphone for voice-activated controls, any other type of interface, and combinations thereof.

In some embodiments, the exercise controller 214 may collect and/or manage exercise information 220. The exercise information 220 may include information (e.g., height, weight, goals) and/or device information (e.g., speed, resistance level, incline). The exercise controller 214 may collect and/or analyze the exercise information 220. For example, the exercise controller 214 use the exercise information to determine a calorie burn value.

As discussed herein, the exercise controller 206 may receive power from the power connection 206. To improve device safety, the power connection 206 may include a power controller 208, such as the power interrupt discussed above with respect to FIG. 1. The power controller 208 may be in communication with a use-sensor 210. The use-sensor 210 may be attached to the flywheel 202. When the exercise device 212 is in use, the use-sensor 210 may detect that the flywheel 202 is rotating. When the exercise device is in use (e.g., when the flywheel 202 is rotating), then the power controller 208 may connect power to the exercise device 212. In some embodiments, when the exercise device is in use, the power controller 208 may connect power to the exercise controller 214.

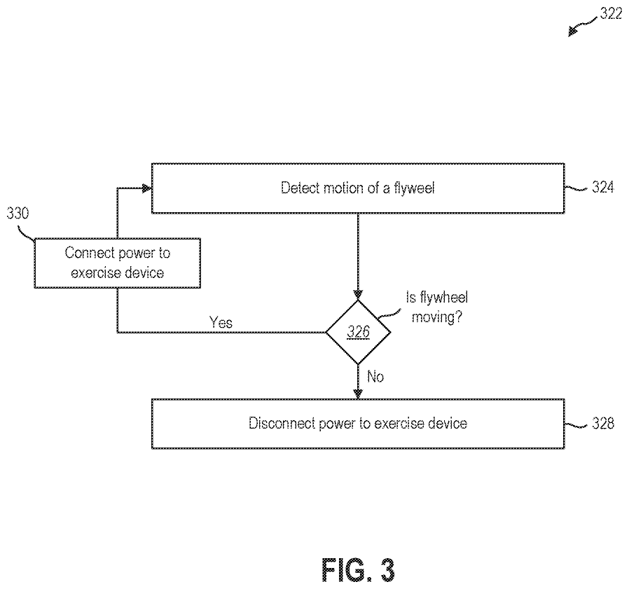

FIG. 3 is a representation of a method 322 for powering an exercise device, according to at least one embodiment of the present disclosure. In accordance with embodiments of the present disclosure, the method 322 may be performed by the use-sensor 110 in communication with the power interrupt 108 of FIG. 1. In other words, the use-sensor 110 in communication with the power interrupt 108 may execute the acts of the method 322 to connect and disconnect power to an exercise device.

The method 322 may include detecting a motion of a flywheel at 324. The use-sensor reading may be measured and/or received from a use-sensor connected to a flywheel (e.g., flywheel 102 of FIG. 1). The method 322 may include determining whether the flywheel is moving at 326. If the flywheel is not moving, then the power interrupt may disconnect power to the exercise device at 328. This may improve the safety of the exercise device by preventing operation of the exercise device when not in use. If the flywheel is moving, then the power interrupt may connect power to the exercise device at 330. The act of receiving the use-sensor reading at 324 may then be repeated indefinitely until the flywheel stops moving (e.g., until the user stops using the exercise device) and power is disconnected from the exercise device.

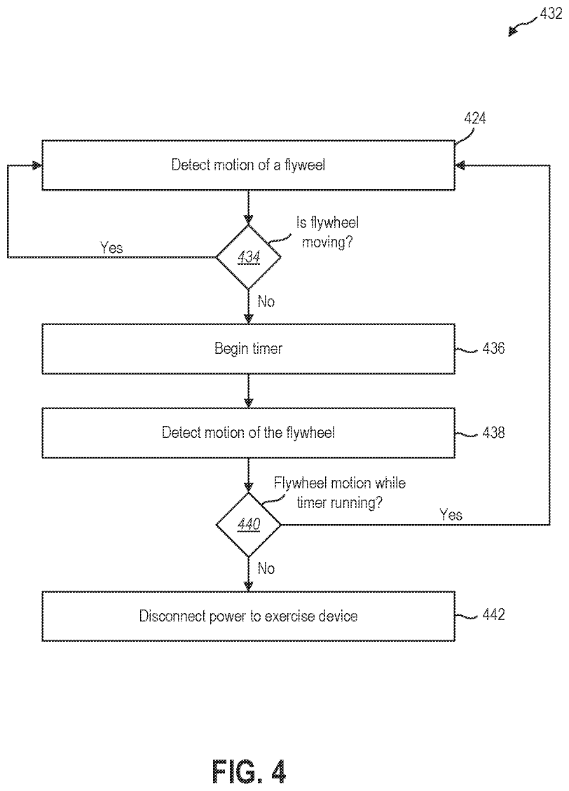

FIG. 4 is a representation of a method 432 for powering an exercise device, according to at least one embodiment of the present disclosure. In accordance with embodiments of the present disclosure, the method 432 may be performed by the use-sensor 110 in communication with the power interrupt 108 of FIG. 1. In other words, the use-sensor 110 in communication with the power interrupt 108 may execute the acts of the method 432 to connect and disconnect power to an exercise device.

The method 432 may include detecting a motion of a flywheel at 424. The motion of the flywheel may be detected by a use-sensor. The method 432 may further include determining whether the flywheel is moving at 434. If the flywheel is moving, then the act 424 of detecting the motion of the flywheel may be repeated until the flywheel is no longer moving. If the flywheel is not moving, then a timer may begin at 436. While the timer is running, the method 432 may continue to detect motion of the treadmill at 438. At 440, the method 432 may determine whether there is motion from the flywheel while the timer is running. If the flywheel does not move while the timer is running, then the method 432 may restart detecting motion of the flywheel at 424. If there is no motion while the timer is running, then power may be disconnected from the exercise device at 442.

In some embodiments, a timer may help prevent power from being prematurely disconnected from the exercise device. For example, a user may get off the exercise device for a period of time mid-exercise, such as for a bathroom break, to perform a body-weight exercise, to take a break, to rehydrate, to grab a snack, for any other reason, and combinations thereof. The user may wish to resume an exercise program. By implementing a timer between the flywheel stopping movement and disconnecting power to the exercise device, the exercise device may stay connected to power during the user's break.

In some embodiments, the timer may be any duration. For example, the timer may be 1 s, 15 s, 30 s, 45 s, 60 s, 2 minutes, 5 minutes, 10 minutes, 15 minutes, 30 minutes, 60 minutes, or any value therebetween. In some embodiments, the timer may be set by the manufacturer (such as in response to a local regulation). In some embodiments, the timer may be set by the user.

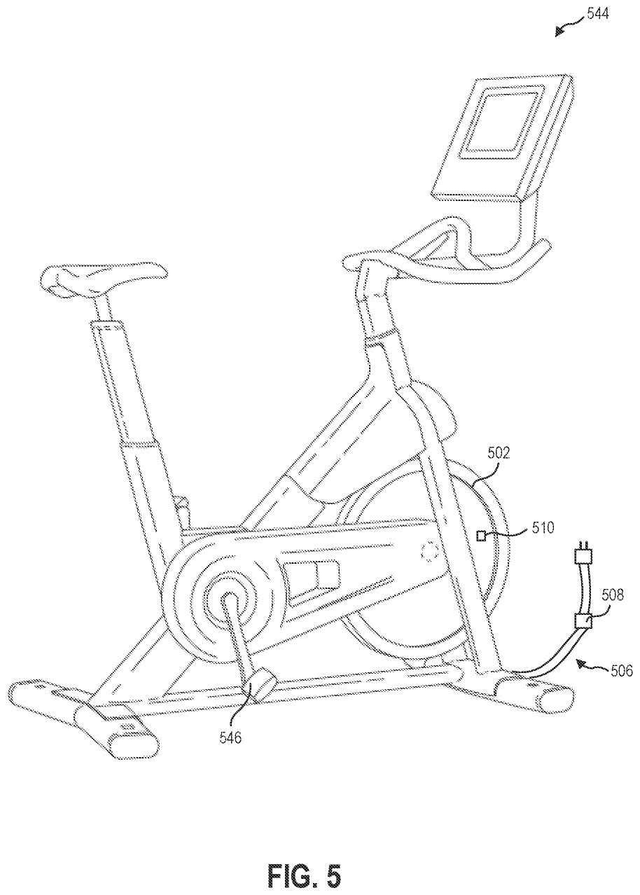

The devices, systems, kits, and methods of the present disclosure may be implemented on any exercise device. Exercise devices consistent with the present disclosure include any exercise device that receives power from an external power source, such as a power outlet or an external battery. Such exercise devices may be considered stationary exercise devices because the general position of the user may not change during the performance of an exercise. FIG. 5-7 are representations of several such exercise devices.

For example, FIG. 5 is a representation of a stationary bicycle 544. To operate the stationary bicycle 544, a user may push on pedals 546 in operational communication with a flywheel 502. The flywheel 502 may provide resistance to rotation of the pedals 546. A use-sensor 510 may be connected to the flywheel 502 to detect motion of the flywheel. A power interrupt 508 may be connected to a power supply 506. The power interrupt 508 may receive signals from the use-sensor 510 to determine whether the stationary bicycle 544 is in use. The power interrupt 508 may connect power to the stationary bicycle 544 when in use and may disconnect power to the stationary bicycle 544 when not in use.

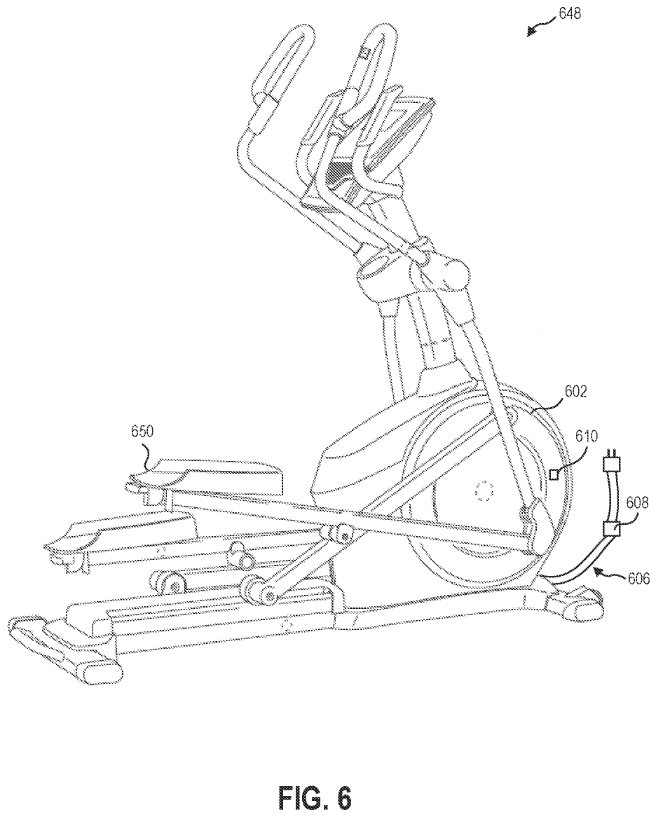

FIG. 6 is a representation of an elliptical machine 648. To operate the elliptical machine 648, a user may push on pedals 650 to rotate a flywheel 602. The flywheel 602 may provide resistance to rotation of the pedals 650. A use-sensor 610 may be connected to the flywheel 602 to detect motion of the flywheel. A power interrupt 608 may be connected to a power supply 606. The power interrupt 608 may receive signals from the use-sensor 610 to determine whether the elliptical machine 648 is in use. The power interrupt 608 may connect power to the elliptical machine 648 when in use, and may disconnect power to the elliptical machine 648 when not in use.

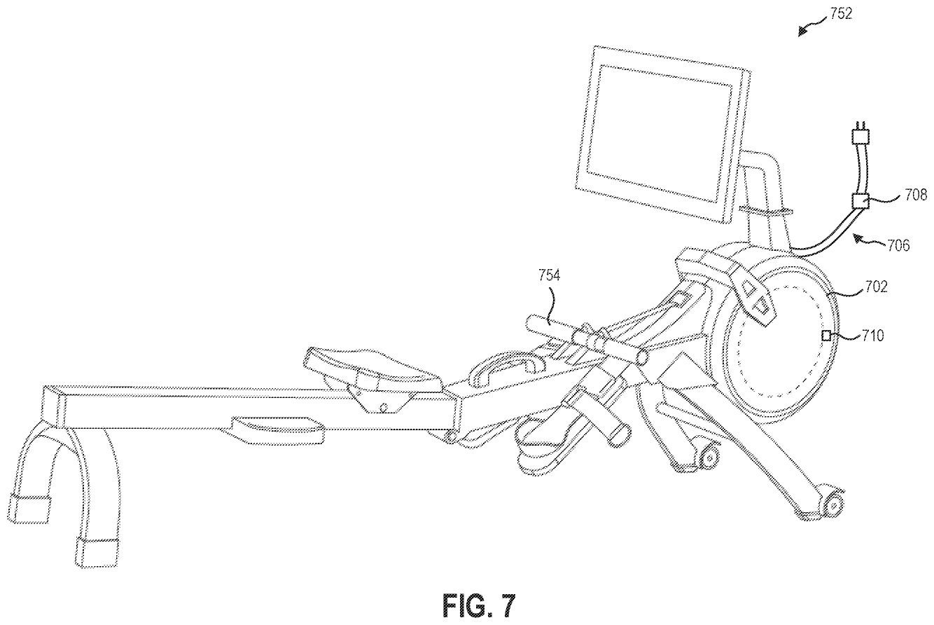

FIG. 7 is a representation of a rower 752. To operate the rower 752, a user may pull on a handle 754 to rotate a flywheel 702. The flywheel 702 may provide resistance to extension of the handle 754. A use-sensor 710 may be connected to the flywheel 702 to detect motion of the flywheel 702. A power interrupt 708 may be connected to a power supply 706. The power interrupt 708 may receive signals from the use-sensor 710 to determine whether the rower 752 is in use. The power interrupt 708 may connect power to the rower 752 when in use, and may disconnect power to the rower 752 when not in use.

### INDUSTRIAL APPLICABILITY

This disclosure generally relates to devices, systems, and methods for providing an automatic shut-off system for an exercise device based on whether a a flywheel is in motion. The flywheel may include a motion sensor, such as an accelerometer, that senses the motion of the flywheel. The motion sensor may be in communication with a power interrupt on a power connector. When the flywheel is in motion, then the sensor may communicate the motion to the power interrupt, and the power interrupt may connect power to the exercise device. When the flywheel is stopped, then the sensor may communicate the lack of motion to the power interrupt, and the power interrupt may disconnect power to the exercise device. This may help to prevent unwanted activation and operation of the exercise device, thereby improving the safety of the device.

In some embodiments, an exercise system includes a resistance element, such as a flywheel. In accordance with embodiments of the present disclosure, the flywheel may be any type of resistance element. In some embodiments, the flywheel may be moved by a movable element which may cause the flywheel to rotate about an axle. For example, the flywheel may be connected to a drive chain of a stationary bicycle. A user may rotate one or more pedals with his or her feet. The pedals may be attached to a crank, which may cause a drive wheel to rotate. The drive wheel may be connected to the flywheel with a chain or belt such that as the drive wheel is rotated, the resistance element is likewise rotated. In some embodiments, the movable element may include pedals of an elliptical machine, a pull and cable for a rower, a pull and cable for strength exercises, any other movable element, and combinations thereof. In some embodiments, the flywheel may be a flywheel on a treadmill.

Rotating the flywheel may cause resistance for the user during an exercise. For example, the flywheel may have a mass and the resistance may include rotating the mass of the flywheel. In some embodiments, the resistance may include starting the flywheel rotating from a stationary position. In some embodiments, the resistance may include keeping the flywheel. The flywheel may experience resistance to rotation, such as through friction from the air or from a brake. In some embodiments, the brake may be a mechanical brake. In some embodiments, the brake may be a magnetic brake.

In some embodiments, an exercise device may include one or more powered systems. A power connector may supply power or be configured to supply power to the powered systems of the exercise device. For example, the power connector may connect an exercise controller to a power supply so that the exercise controller may change exercise elements of the exercise device (e.g., incline, resistance, speed). The power connector may include an automatic shut-off system, such as a power interrupt. The power interrupt may be located between the exercise device and the power supply. In other words, the power interrupt may be located on the power connector between the exercise device and the power supply such that the power interrupt is capable of interrupting the power connection between the power supply and the exercise device. For example, the power interrupt may be able to connect and disconnect power to the exercise device by operating a switch to open and close a connection in the power connector.

In some embodiments, the power interrupt may be an automatic shut-off. In other words, the power interrupt may be configured to automatically disconnect power to the exercise device. The power interrupt may automatically disconnect power to the exercise device based on one or more conditions. For example, the power interrupt 108 may connect and/or disconnect power to the exercise device based on whether the exercise device is being used. In this manner, the exercise device may only receive power when in use. This may help to reduce the risk of an electrical short, an electrical overload, or other electrical problems. This may help to reduce the risk of fire or other damage to the exercise device and/or the users and home of the users caused by electrical problems.

In some embodiments, the exercise device may include a use-sensor. The use-sensor may detect use of the exercise device. The use-sensor may detect use of the exercise device in any manner. For example, the use-sensor may be connected to the flywheel. The use-sensor may detect a motion of the flywheel. As discussed above, the flywheel will rotate when the exercise device is in use, either through the user applying a force on the flywheel through the movable element or by being driven by a motor. Thus, by placing the use-sensor on the flywheel, the use-sensor may help to determine whether the exercise device is in use.

The use-sensor may be in communication with the power interrupt. The use-sensor may send a signal to the power interrupt indicating whether the exercise device is being used. If the signal indicates that the exercise device is in use, then the power interrupt may connect power to the exercise device through the power connector. If the signal (or lack thereof) indicates that the exercise device is not in use, then the power interrupt may disconnect power from the exercise device.

The use-sensor may detect use of the exercise device through the flywheel in any manner. For example, the use-sensor may be a motion sensor configured to detect rotation of the flywheel. If the motion sensor detects that the flywheel is rotating, then the motion sensor may transmit the motion to the power interrupt. In some examples, the use-sensor may be an accelerometer such that the accelerometer detects the motion of the flywheel. In some embodiments, the accelerometer may be configured to measure multiple axes. The accelerometer may be oriented to measure a rotational acceleration. If the accelerometer measures a rotational acceleration, then the accelerometer may send a signal to the power interrupt indicating that the exercise device is in use. If the accelerometer measures an acceleration other than a rotational acceleration, then the accelerometer may determine that the flywheel is not in use (e.g., the exercise device could be in transport, moved around a user's apartment, and so forth). In some embodiments, the use-sensor may be any other type of sensor. For example, the use-sensor may be a force-sensor configured to determine the presence of a radially outward force.

In accordance with embodiments of the present disclosure, the power interrupt may have a threshold signal limit. For example, the use-sensor may send a signal that is representative of a rotation of the flywheel. The power interrupt may have a minimum flywheel rotation to provide power to the exercise device. The power interrupt may determine the flywheel rotation using information received from the use-sensor. If the signal received from the use-sensor is above the threshold signal limit, then the power interrupt may determine that the exercise device is being used and may connect power to the exercise device. Put another way, the power interrupt may determine that the flywheel is being intentionally rotated by the user. If the signal received from the use-sensor is below the threshold signal limit, then the power interrupt may determine that the exercise device is not being used. Put another way, the power interrupt may determine that the flywheel is not being rotated or that the flywheel is being moved accidently (such as by bumping, jostling, moving of the exercise device, and so forth).

In some embodiments, the flywheel has a threshold motion to determine whether the exercise device is in use. The threshold motion may be any type of motion, for example, the threshold motion may be a threshold rotational acceleration. In some examples, the threshold motion may be a threshold number of rotations. In some embodiments, if the detected rotation of the flywheel is greater than the threshold, then the power interrupt may connect power to the exercise device. If the detected rotation of the flywheel is less than the threshold, then the power interrupt may disconnect power to the exercise device. For example, the threshold may be a threshold rotational acceleration. The power interrupt may determine that the detected rotational acceleration is less than the threshold rotational acceleration before disconnecting the power from the exercise device.

In some embodiments, the power interrupt may determine that the exercise device is being used if the signal received from the use-sensor indicates that the flywheel has undergone a revolution percentage (e.g., the angle of the flywheel rotated divided by 360). For example, the power interrupt may determine that the exercise device is being used if the flywheel undergoes a revolution percentage of 10%, 25%, 50%, 75%, 100%, 150%, 200%, or any value therebetween. Determining that the flywheel has undergone the revolution percentage may provide an indication that the flywheel is being rotated intentionally, and therefore that the exercise device is being used.

In some embodiments, the use-sensor may only be powered when the exercise device is in use. For example, the flywheel may include one or more power generators that generate power when the flywheel is rotating. The use-sensor may be configured to automatically send a signal to the power interrupt when it receives power from the one or more power generators.

In some embodiments, the use-sensor and the power interrupt may have separate power sources (e.g., the use-sensor and the power interrupt may be separately powered). For example, the use-sensor may be powered by power generated by rotation of the flywheel, and the power interrupt may be powered by power received from the outlet. In some embodiments, the use-sensor and the exercise device may have separate power sources. For example, the power interrupt may include a controller switch that connects and disconnects power to the controller of the exercise device. A sensor power connection, separate from the controller switch, may extend from the use-sensor to the power interrupt. In this manner, the use-sensor may receive power even when power interrupt has disconnected power to the main exercise device.

In some embodiments, the use-sensor may continuously provide a signal to the power interrupt. The power interrupt may receive and interpret the signal received from the use-sensor. In some embodiments, the power interrupt may determine that the exercise device is in use if, based on the signal received from the use-sensor, it determines that the flywheel has been moving for a threshold duration. In some embodiments, the threshold duration may be 0.1 s, 0.25 s, 0.5 s, 0.75 s, 1.0 s, 2.0 s, or any value therebetween. This may help prevent the power interrupt 108 from providing power to the exercise device when the exercise device is not in use.

In some embodiments, the power interrupt may determine whether the exercise device is in use. For example, the use-sensor may provide sensor data to the power interrupt, and the power interrupt may interpret the sensor data to determine whether the exercise device is in use, as discussed herein. In some embodiments, the use-sensor may determine whether exercise device is in use. For example, the use-sensor may interpret the sensor data it collects and determine whether the exercise device is in use, as discussed herein. The use-sensor may then communicate the status of the exercise device (e.g., in-use or not in-use) to the power interrupt.

In some embodiments, the use-sensor may only send a signal to power interrupt to send sensor data and/or indicate the status of the exercise device. In some embodiments, the use-sensor may be in continuous communication with the power interrupt when the exercise device is in use. If the use-sensor stops communicating with the power interrupt, then the power interrupt may infer that the exercise device is no longer in use, and the power interrupt may disconnect power to the exercise device.

In some embodiments, the use-sensor may be in wireless communication with the power interrupt using a wireless connection, including wireless communication protocols as Wi-Fi, Bluetooth, Zigbee, NFC, infrared signals, any other wireless communication protocol, and combinations thereof. In some embodiments, the use-sensor may be in wired communication with the power interrupt using a wired connection.

In some embodiments, an exercise system includes an exercise device having a resistance element, such as the flywheel. The exercise controller of exercise device may receive power from a power connection. In some embodiments, the exercise controller may control any element of the exercise device, collect exercise information to the user, display exercise information to the user, communicate with a remote computing device, perform any other function related to the exercise device, and combinations thereof.

In some embodiments, the exercise controller may be configured to change one or more elements of the device configuration, such as resistance level, incline level, belt speed, seat position, handle position, footrest position, any other device configuration element, and combinations thereof. In some embodiments, the exercise controller may include one or more exercise programs that involve periodic changes in the device configuration, such as changes in the incline and/or resistance. The device controller may execute an exercise program by making the changes to the device configuration automatically, without user input.

In some embodiments, the device controller may include a user interface. Through the user interface, a user may input commands and/or information into the exercise device. For example, the user may select an exercise program, change one or more elements of the device configuration, input user information such as weight, height, exercise goals, select media content to consume while exercising (or otherwise), provide any other input, and combinations thereof. In some embodiments, the user interface may be any type of interface, including one or more physical buttons located somewhere on the exercise device, a touch-screen display, a microphone for voice-activated controls, any other type of interface, and combinations thereof.

In some embodiments, the exercise controller may collect and/or manage exercise information. The exercise information may include information (e.g., height, weight, goals) and/or device information (e.g., speed, resistance level, incline). The exercise controller may collect and/or analyze the exercise information. For example, the exercise controller may use the exercise information to determine a calorie burn value.

As discussed herein, the exercise controller may receive power from the power connection. To improve device safety, the power connection may include a power controller. The power controller may be in communication with a use-sensor. The use-sensor may be attached to the flywheel. When the exercise device is in use, the use-sensor may detect that the flywheel is rotating. When the exercise device is in use (e.g., when the flywheel is rotating), then the power controller may connect power to the exercise device. In some embodiments, when the exercise device is in use, the power controller may connect power to the exercise controller.

In some embodiments, a method may include detecting a motion of a flywheel. The use-sensor reading may be measured and/or received from a use-sensor connected to a flywheel. The method may include determining whether the flywheel is moving. If the flywheel is not moving, then the power interrupt may disconnect power to the exercise device. This may improve the safety of the exercise device by preventing operation of the exercise device when not in use. If the flywheel is moving, then the power interrupt may connect power to the exercise device. The act of receiving the use-sensor reading may then be repeated indefinitely until the flywheel stops moving (e.g., until the user stops using the exercise device) and power is disconnected from the exercise device.

In some embodiments, a method may include detecting a motion of a flywheel. The motion of the flywheel may be detected by a use-sensor. The method may further include determining whether the flywheel is moving. If the flywheel is moving, then detecting the motion of the flywheel may be repeated until the flywheel is no longer moving. If the flywheel is not moving, then a timer may begin. While the timer is running, the method may continue to detect motion of the treadmill. In some embodiments, the method may determine whether there is motion from the flywheel while the timer is running. If the flywheel does not move while the timer is running, then the method may restart detecting motion of the flywheel. If there is no motion while the timer is running, then power may be disconnected from the exercise device at.

In some embodiments, a timer may help prevent power from being prematurely disconnected from the exercise device. For example, a user may get off the exercise device for a period of time mid-exercise, such as for a bathroom break, to perform a body-weight exercise, to take a break, to rehydrate, to grab a snack, for any other reason, and combinations thereof. The user may wish to resume an exercise program. By implementing a timer between the flywheel stopping movement and disconnecting power to the exercise device, the exercise device may stay connected to power during the user's break.

In some embodiments, the timer may be any duration. For example, the timer may be 1 s, 15 s, 30 s, 45 s, 60 s, 2 minutes, 5 minutes, 10 minutes, 15 minutes, 30 minutes, 60 minutes, or any value therebetween. In some embodiments, the timer may be set by the manufacturer (such as in response to a local regulation). In some embodiments, the timer may be set by the user.

The devices, systems, kits, and methods of the present disclosure may be implemented on any exercise device. Exercise devices consistent with the present disclosure include any exercise device that receives power from an external power source, such as a power outlet or an external battery. Such exercise devices may be considered stationary exercise devices because the general position of the user may not change during the performance of an exercise.

For example, to operate a stationary bicycle 544, a user may push on pedals in operational communication with a flywheel. The flywheel may provide resistance to rotation of the pedals. A use-sensor may be connected to the flywheel to detect motion of the flywheel. A power interrupt may be connected to a power supply. The power interrupt may receive signals from the use-sensor to determine whether the stationary bicycle is in use. The power interrupt may connect power to the stationary bicycle when in use and may disconnect power to the stationary bicycle when not in use.

In some embodiments, to operate an elliptical machine, a user may push on pedals to rotate a flywheel. The flywheel may provide resistance to rotation of the pedals. A use-sensor may be connected to the flywheel to detect motion of the flywheel. A power interrupt may be connected to a power supply. The power interrupt may receive signals from the use-sensor to determine whether the elliptical machine is in use. The power interrupt may connect power to the elliptical machine when in use, and may disconnect power to the elliptical machine when not in use.

In some examples, to operate a rower, a user may pull on a handle to rotate a flywheel. The flywheel may provide resistance to extension of the handle. A use-sensor may be connected to the flywheel to detect motion of the flywheel. A power interrupt may be connected to a power supply. The power interrupt may receive signals from the use-sensor to determine whether the rower is in use. The power interrupt may connect power to the rower when in use, and may disconnect power to the rower when not in use.

Following are sections of embodiments of the present disclosure:
A1. An automatic-shut-off system for an exercise device, comprising:
   a power connector configured to connect the exercise device to a power source;
   a flywheel connected to the exercise device;
   a use-sensor configured to detect a motion of the flywheel; and
   a power interrupt located on the power connector between the power source and the exercise device, wherein the power interrupt is configured to disconnect a power connection to the exercise device when the motion sensor detects that the flywheel is not moving.
A2. The system of section A1, wherein the use-sensor is an accelerometer.
A3. The system of section A2, wherein the accelerometer detects the motion of the flywheel when the accelerometer detects a rotational acceleration.
A4. The system of any of sections A1-A3, wherein the use-sensor detects the motion of the flywheel when a rotational acceleration of the flywheel is greater than a threshold.
A5. The system of any of sections A1-A4, wherein the use-sensor is located on the flywheel.
A6. The system of any of sections A1-A5, wherein the use-sensor is in wireless communication with the power interrupt.
A7. The system of any of sections A1-A6, wherein the use-sensor is in wired communication with the power interrupt.
A8. The system of any of sections A1-A7, wherein the use-sensor has a separate power source.
B1. A method for controlling power for an exercise device, comprising:
   detecting a motion of a flywheel on the exercise device using a use-sensor;
   determining whether the flywheel is moving; and
   after determining whether the flywheel is moving, if the flywheel is not moving, disconnecting the exercise device from a power source with a power interrupt.
B2. The method of section B1, wherein the use-sensor is an accelerometer, and wherein determining whether the flywheel is moving includes detecting a rotational acceleration using the accelerometer.
B3. The method of section B2, wherein determining whether the flywheel is moving includes determining whether the detected rotational acceleration is less than a threshold rotational acceleration, and wherein the power interrupt determines that the detected rotational acceleration is less than the threshold rotational acceleration before disconnecting the exercise device from the power source.
B4. The method of any of sections B1-B3, wherein, if the flywheel is moving, the power interrupt connects the exercise device to the power source.
B5. The method of any of sections B1-B4, wherein the use-sensor is in wireless communication with the power interrupt.
B6. The method of any of sections B1-B5, further comprising:
   if the flywheel is not moving, starting a timer;
   while the timer is running, detecting a motion of the flywheel; and
   if the flywheel does not move while the timer is running, then disconnecting the exercise device from the power source.
C1. An exercise device, comprising:
   an exercise controller configured to change one or more device configurations;
   a power supply configured to supply power to the exercise controller, the power supply including a power interrupt configured to connect or disconnect power to the exercise controller; and
   a use-sensor in communication with the power interrupt, wherein the use-sensor is configured to detect a motion of a flywheel on the exercise device, wherein, when the flywheel is not moving, then the power interrupt disconnects power to the exercise controller.
C2. The exercise device of section C1, wherein the use-sensor is an accelerometer.
C3. The exercise device of any of sections C1-C2, wherein the use-sensor and the controller are separately powered.
C4. The exercise device of any of sections C1-C3, wherein the use-sensor receives power from the power supply when the power interrupt disconnects power to the exercise controller.
C5. The exercise device of any of sections C1-C4, wherein the use-sensor is in wireless communication with the controller.
C6. The exercise device of any of sections C1-C5, wherein the exercise device is a stationary bicycle.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An automatic-shut-off system for an exercise device, comprising:
a power connector configured to connect the exercise device to a power source;
a flywheel connected to the exercise device;
a use-sensor configured to detect a motion of the flywheel; and
a power interrupt located on the power connector between the power source and the exercise device, wherein the power interrupt is configured to disconnect a power connection to the exercise device when the motion sensor detects that the flywheel is not moving.

2. The system of claim 1, wherein the use-sensor is an accelerometer.

3. The system of claim 2, wherein the accelerometer detects the motion of the flywheel when the accelerometer detects a rotational acceleration.

4. The system of claim 1, wherein the use-sensor detects the motion of the flywheel when a rotational acceleration of the flywheel is greater than a threshold.

5. The system of claim 1, wherein the use-sensor is located on the flywheel.

6. The system of claim 1, wherein the use-sensor is in wireless communication with the power interrupt.

7. The system of claim 1, wherein the use-sensor is in wired communication with the power interrupt.

8. The system of claim 1, wherein the use-sensor has a separate power source.

9. A method for controlling power for an exercise device, comprising:
detecting a motion of a flywheel on the exercise device using a use-sensor;
determining whether the flywheel is moving; and
after determining whether the flywheel is moving, if the flywheel is not moving, disconnecting the exercise device from a power source with a power interrupt.

10. The method of claim 9, wherein the use-sensor is an accelerometer, and wherein determining whether the flywheel is moving includes detecting a rotational acceleration using the accelerometer.

11. The method of claim 10, wherein determining whether the flywheel is moving includes determining whether the detected rotational acceleration is less than a threshold rotational acceleration, and wherein the power interrupt determines that the detected rotational acceleration is less than the threshold rotational acceleration before disconnecting the exercise device from the power source.

12. The method of claim 9, wherein, if the flywheel is moving, the power interrupt connects the exercise device to the power source.

13. The method of claim 9, wherein the use-sensor is in wireless communication with the power interrupt.

14. The method of claim 9, further comprising:
if the flywheel is not moving, starting a timer;
while the timer is running, detecting a motion of the flywheel; and
if the flywheel does not move while the timer is running, then disconnecting the exercise device from the power source.

15. An exercise device, comprising:
an exercise controller configured to change one or more device configurations;
a power supply configured to supply power to the exercise controller, the power supply including a power interrupt configured to connect or disconnect power to the exercise controller; and
a use-sensor in communication with the power interrupt, wherein the use-sensor is configured to detect a motion of a flywheel on the exercise device, wherein, when the flywheel is not moving, then the power interrupt disconnects power to the exercise controller.

16. The exercise device of claim 15, wherein the use-sensor is an accelerometer.

17. The exercise device of claim 15, wherein the use-sensor and the controller are separately powered.

18. The exercise device of claim 15, wherein the use-sensor receives power from the power supply when the power interrupt disconnects power to the exercise controller.

19. The exercise device of claim 15, wherein the use-sensor is in wireless communication with the controller.

20. The exercise device of claim 15, wherein the exercise device is a stationary bicycle.
